(19) United States
(12) Patent Application Publication
(10) Pub. No.: US 2025/0121533 A1
(43) Pub. Date: Apr. 17, 2025

(54) SYSTEM FOR PRODUCING PLASTIC FILMS AS WELL AS METHOD

(71) Applicant: Brückner Maschinenbau GmbH, Siegsdorf (DE)

(72) Inventors: Quirin WEIDACHER, Traunstein (DE); Benjamin DÜRR, Traunstein (DE)

(21) Appl. No.: 18/916,019

(22) Filed: Oct. 15, 2024

(30) Foreign Application Priority Data
Oct. 17, 2023 (DE) 10 2023 128 364.2
Aug. 14, 2024 (DE) 10 2024 123 258.7

(51) Int. Cl. B29C 35/00; F25B 30/00

(52) U.S. Cl. CPC B29C 35/00; F25B 30/00

(57) ABSTRACT

A system for producing plastic films has a source unit, a heat sink unit and a heat pump. The source unit comprises an exhaust heat outlet that is connected thermally to the feed of the heat pump and the heat sink unit comprises a process heat supply that is connected thermally to the outlet of the heat pump.

Moreover, a method for operating the system is shown.

### FIELD OF THE DISCLOSURE

The disclosure relates to a system for producing plastic films as well as a method for operating such a system.

### BACKGROUND

Systems for producing plastic films are known and typically comprise at least an extruder and a stretching unit.

The production of plastic films in such systems is very energy intensive as the various units of the system, in particular the stretching unit, require process heat.

For this reason, it is known that the individual units of the system are designed energy efficiently and potentially comprise devices for heat recovery.

Further increases in energy efficiency are desirable.

### SUMMARY

There is provided a system for producing plastic films as well as a method for operating such a system which has improved energy efficiency.

The system has a source unit, a heat sink unit and a heat pump, wherein the heat pump comprises a feed for heat and an outlet for useful heat. The source unit comprises an exhaust heat outlet that is thermally connected to the feed of the heat pump and the heat sink unit comprises a process heat feed that is thermally connected to the outlet of the heat pump.

The inventors have recognised that an increase in energy efficiency is possible as the exhaust heat of one of the units can be used as process heat for another unit. By means of the heat pump, it is now possible to use exhaust heat from certain units of the system and provide it as process heat for other units of the system. The energy efficiency of the system is improved as a result.

A thermal connection within the meaning of this disclosure occurs, for example, by means of a heat transfer circuit.

The system is, for example, a system for producing biaxially stretched films, such as, for example, polypropylene films (BOPP), polyethylene terephthalate films (BOPET), polyamide films (BOPA), polyethylene films (BOPE), polylactic acid films (BOPLA), capacitor films (BOPP-C) or battery separator films (BSF).

In an embodiment, the feed of the heat pump is an evaporator and/or the outlet of the heat pump is a condenser, thereby making a thermal connection to the heat pump possible efficiently.

For example, the compressor is arranged downstream of the feed and upstream of the outlet. The throttle can be arranged downstream of the outlet and upstream of the feed.

In an embodiment, the system comprises a first heat transfer circuit that thermally connects the source unit to the heat pump. The first heat transfer circuit constitutes an efficient and low-loss thermal connection between the heat pump and the source unit.

The first heat transfer circuit can comprise a pump for the heat transfer medium. The heat transfer medium can be a thermal oil or pressurised water.

For example, the first heat transfer circuit comprises a first heat exchanger, in particular an air heat exchanger that is thermally connected to the exhaust heat outlet of the source unit. An adaptation of the source unit is therefore not necessary.

To further increase the energy efficiency, the system can comprise a secondary source unit and the first heat transfer circuit can comprise a second heat exchanger, wherein an exhaust heat outlet of the secondary source unit is thermally connected in particular directly to the second heat exchanger.

For example, the second heat exchanger is arranged upstream of the first heat exchanger and/or downstream of the feed of the heat pump.

In an embodiment, the exhaust heat outlet of the source unit is an exhaust air outlet, wherein the first heat exchanger comprises a gas scrubber and a liquid heat exchanger. In this way, the heat exchanger fulfils a dual function.

In an embodiment, the system comprises a second heat transfer circuit that thermally connects the heat sink unit to the heat pump. Thus, an efficient and low-loss thermal connection is provided between the heat pump and the heat sink unit.

The second heat transfer circuit comprises, in particular, a pump for the heat transfer medium. The heat transfer medium can be a thermal oil or pressurised water.

In an embodiment, the system comprises an additional heater that is located in the second heat transfer circuit downstream of the heat pump and upstream of the heat sink unit. By means of the additional heating, demand peaks in process heat of heat sink unit can be mitigated so that a heat pump with less power can be installed.

To be capable of operating the additional heater independently of the heat pump, the second heat transfer circuit can comprise a bypass section with a bypass valve, wherein the bypass section opens downstream of the heat pump and upstream of the additional heater and/or originates from a point upstream of the heat pump and downstream of the heat sink unit.

In an embodiment, the system comprises two heat pumps that are connected in parallel between the source unit and the heat sink unit, in particular wherein the heat pumps comprise different temperature performance ranges. Both heat pumps can each be designed for one narrow temperature performance range, thereby making it possible to operate them more efficiently than an individual heat pump.

In particular, the source unit is connected thermally to the feeds of each of the heat pumps and the heat sink unit is connected thermally to the outlets of each of the heat pumps.

To increase the efficiency, the feeds of the heat pumps can be arranged in series in the first heat transfer circuit and/or the outlets of the heat pumps can be arranged in series in the second heat transfer circuit.

Arranging the outlets in the second heat transfer circuit in the reverse order as the feeds of the first heat transfer circuit with regard to the flow of the heat transfer medium can be particularly efficient.

In an embodiment, the source unit or the secondary source unit can be a stretching unit, in particular a transverse direction orienter or a simultaneous stretching unit, an extrusion unit, a casting unit and/or a draw roller unit, thereby efficiently making use of the exhaust heat of these units.

The heat sink unit can be a stretching unit, in particular a transverse direction orienter or a machine direction orienter, a crystalliser, a raw material drying unit and/or a water bath of a simultaneous stretching unit, thereby making it possible to use exhaust heat to meet the process heat requirements of these units. A heat sink can also be a preheating zone of a transverse direction orienter.

The exhaust heat of an extruder of the extrusion unit and/or the casting unit is available in particular in cooling water; the exhaust heat of the oven of the stretching unit, a metering device of the extrusion unit and the draw roller is available in the exhaust air.

The source unit is in particular a transverse direction orienter.

In an embodiment, the source unit comprises a device for heat recovery, wherein the exhaust heat outlet of the device for heat recovery is the exhaust heat outlet of the source unit. In this way, the exhaust heat of the source unit can be used particularly efficiently.

There is further provided a method for operating a system for producing plastic films comprising a source unit, a heat sink unit and a heat pump. The method comprises the following:
feeding the exhaust heat of the source unit to the heat pump, and
feeding useful heat from the heat pump to the heat sink unit as process heat.

The features and advantages described for the system apply equally to the method and vice versa. Moreover, the components of the system are designed and set up to execute the method.

For example, the exhaust heat of the source unit is the exhaust heat of a device for heat recovery of the source unit, thereby increasing efficiency further.

To met demand peaks, other useful heat can be supplied to the heat sink unit to the useful heat of the heat pump, which generates an additional heating of the system.

For the efficient supply of the other useful heat, the other useful heat can be generated in a second heat transfer circuit of the system, which conveys the useful heat of the heat pump to the heat sink unit.

To protect the heat pump, a bypass valve can be opened in a bypass section of the second heat transfer circuit, which bypasses the heat pump, and a shut-off valve can be closed upstream of the heat pump if the return temperature from the heat sink unit in the second heat transfer circuit exceeds the temperature in the second heat transfer circuit directly downstream of the heat pump.

### BRIEF DESCRIPTION OF THE DRAWINGS

Additional advantages and features of the disclosure can be found in the following description as well as in the attached drawings to which reference is made.

FIG. 1 shows a system for producing plastic films according to an embodiment of the disclosure in a perspective, schematic view,

FIG. 2 shows an extremely schematic view of part of the system of FIG. 1 according to a first embodiment according to the disclosure,

FIG. 3 shows a schematic flow diagram of an embodiment of a method according to the disclosure,

FIG. 4 shows an extremely schematic view of part of a system of FIG. 1 in a second embodiment according to the disclosure,

FIG. 5 shows a schematic view of a gas scrubber as part of a further embodiment of the system according to the disclosure,

FIG. 6 shows a schematic view of a part of a first heat transfer circuit of a system according to the disclosure in a further embodiment,

FIG. 7 shows an extremely schematic view of part of a system of FIG. 1 in a third embodiment according to the disclosure,

FIG. 8 shows an extremely schematic view of part of a system of FIG. 1 in a fourth embodiment according to the disclosure,

FIG. 9 shows an extremely schematic view of part of a system of FIG. 1 in a fifth embodiment according to the disclosure,

FIG. 10 shows an extremely schematic view of part of a system of FIG. 1 in a sixth embodiment according to the disclosure,

FIG. 11 shows an extremely schematic view of part of a system of a further embodiment according to the disclosure,

### DETAILED DESCRIPTION

Lists having a plurality of alternatives connected by “and/or”, for example “A, B and/or C” are to be understood to disclose an arbitrary combination of the alternatives, i.e. the lists are to be read as “A and/or B and/or C” or as “at least one of A, B or C”. The same holds true for listings with more than three items.

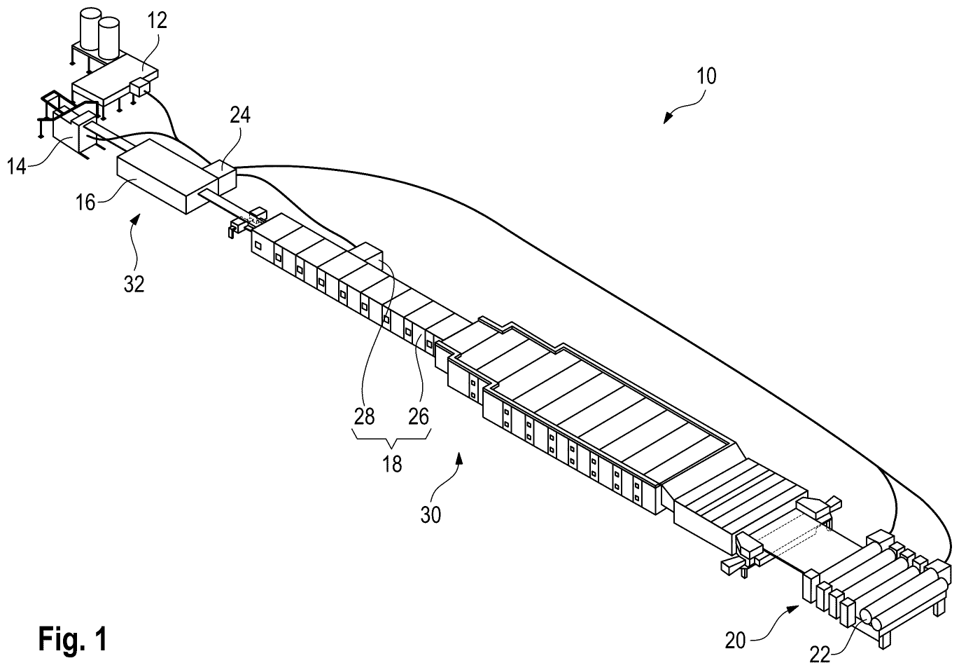

In FIG. 1, a system 10 for producing plastic films is shown extremely schematically which comprises several different units and devices.

In the shown example, the system 10 comprises an extrusion unit 12, a casting unit 14, a machine direction orienter 16 (MDO), a transverse direction orienter 18 (TDO), a draw roller unit 20, a winder unit 22 as well as a heat pump unit 24.

The film produced is, for example, a biaxially stretched film, such as polypropylene film (BOPP), polyethylene terephthalate film (BOPET), polyamide film (BOPA), polyethylene film (BOPE), polylactic acid film (BOPLA), capacitor film (BOPP-C) or battery separator film (BSF).

To produce plastic films, a film is created on the chill roll of a casting unit 14 by means of an extrusion unit 12. To this end, the extrusion unit 12 generates a melt from the starting products, such as granular material, said melt being applied to the chill roll, thereby creating the film.

This film is conveyed from the casting unit 14 to the machine direction orienter 16. In the machine direction orienter 16, the film is stretched in the machine direction in order to obtain a stretched film.

In the machine direction orienter 16, the film runs over a plurality of rollers that are heated in order to heat the film to the desired temperature in order to be capable of being stretched.

The stretching takes place in the machine direction, i.e. in the drawing direction, between at least two of the rollers present in the machine direction orienter 16 so that the film becomes a stretched film.

The stretched film attained is conveyed by the machine direction orienter 16 to the transverse direction orienter 18 and stretched in the transverse direction orienter in the transverse direction.

Along the drawing direction of the system 10, the transverse direction orienter 18 has an oven 26 with different zones for treating the film.

The film is heated in the first zone, also termed the preheating zone. In the subsequent second zone (“stretching zone”), the film is stretched in the transverse direction so that its width is greater and its thickness is less at the end of the second zone than it was at the start.

After completing the stretching, the film then passes through the third and further zones (termed “heat treatment zone”, “further heating zone” and/or “annealing zone”), in which a relaxation of the film, for example, can take place at high temperatures. One or more of these zones can act as sources for exhaust heat.

Subsequently, the film passes through a further zone (“cooling zone”), wherein the film is cooled in the last zone.

A further zone is termed the neutral zone and serves to separate the zones. The neutral zone is, for example, an empty space without any ventilation.

The zones of the transverse direction orienter 18 can also be divided differently and/or designed different in their lengths. For example, fewer or shorter neutral zones can be provided or the neutral zones can be arranged at other points, also additionally. Changes in the remaining zones are also conceivable.

After the transverse direction orienter 18, the now biaxially stretched film runs through the draw roller unit 20 and is wound by means of the winder unit 22.

It is also conceivable that the system 10 is designed in another way, for example by means of a simultaneous stretching unit that replaces or supplements the machine direction orienter 16 and the transverse direction orienter 18.

At least the machine direction orienter 16 and the transverse direction orienter 18 require process heat during operation of the system.

Simultaneously, exhaust heat forms in the machine direction orienter 16 and the transverse direction orienter 18, but also in further units.

For example, the extruder or extruders of the extrusion unit 12 and also the chill roll or the cooling basin/water bath of the casting unit 14 generate exhaust heat that exist in both cases in the form of heated cooling water.

For example, the machine direction orienter 16 and the transverse direction orienter 18, but also the metering device of the extrusion unit 12, the casting unit 14 and the draw roller unit 20 generate warm exhaust air as exhaust heat.

The transverse direction orienter 18, for example, can also comprise a device 28 for heat recovery in addition to the described zones. The device 28 for heat recovery is optional.

This device 28 receives both fresh air from the environment as well as exhaust air from the oven 26, for example the heat treatment zone and/or the cooling zone. By means of the exhaust air from the oven 26, the fresh air for the oven is preheated so that parts of the exhaust heat of the oven 26 can be fed directly into the oven 26 again as process heat.

The device 28 for heat recovery is known per se and also the units 12, 14, 16, 18, 20 and 22 are known per se.

The heat pump unit 24 is only shown in FIG. 1 schematically and can be in contact thermally with each of the individual units 12, 14, 16, 18, 20 and 22 in order to receive exhaust heat of the units 12 to 22 and/or to provide process heat for one of these units 12 to 22.

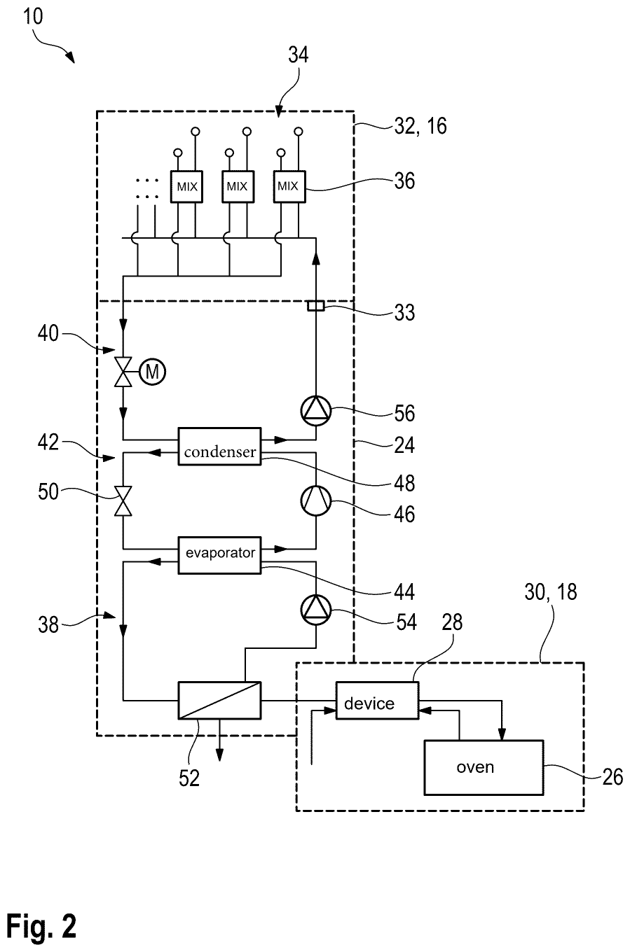

In FIG. 2, a part of the system 10 according to FIG. 1 is shown extremely schematically. A source unit 30, a heat sink unit 32 as well as the heat pump unit 24 can be seen.

In this embodiment, the source unit 30 is the transverse direction orienter 18 of the system 10. Other units of the system 10 can also be taken into consideration as the source unit 30, for example other stretching units, such as the machine direction orienter 16 (or if present, also a simultaneous stretching unit), the extrusion unit 12, the casting unit 14 and/or the draw roller unit 20.

The source can be a certain zone of the source unit 30, for example the annealing zone. It is also conceivable that several zones of the source unit 30 are the source, for example, the annealing zone and the preheating zone, the annealing zone and the heating zone or the annealing zone, the preheating zone and the heating zone.

In the shown embodiment, the heat sink unit 32 is the machine direction orienter 16. It is however also conceivable that the heat sink unit 32 is a crystalliser of the extrusion unit 12, a raw material drying unit of the extrusion unit 12 and/or a water bath of a simultaneous stretching unit.

The heat pump unit 24 thermally connects the source unit 30 to a heat sink unit 32 and provides process heat to the heat sink unit 32.

Of the transverse direction orienter 18 as the source unit 30, only the oven 26 and the device 28 for heat recovery are shown in FIG. 2.

The exhaust heat of the device 28 for heat recovery, i.e. the slightly cooled exhaust air from the oven 26 is provided to the heat pump unit 24 as exhaust heat of the source unit 30.

The machine direction orienter 16 is indicated in FIG. 2 also only very schematically, wherein the machine direction orienter 16 comprises an entrance 33 as process heat supply, several rollers 34 and several mixing units 36.

A heat transfer medium, for example a thermal oil or pressurised water, flows through the rollers 3, thereby temperature controlling these.

The mixing units 36 receive both the flow of the heat transfer medium leading to the rollers 34 as well as coming from the rollers 34 and are configured to set the temperature of the heat transfer medium to the rollers (inlet temperature), in particular individually for individual rollers 34 or subgroups of rollers 34.

In the shown embodiment, the heat pump unit 24 comprises a first heat transfer circuit 38, a second heat transfer circuit 40 as well as a heat pump 42.

The heat pump 42 comprises, as known per se, an evaporator 44, a compressor 46, a condenser 48 as well as a throttle 50.

The evaporator 44 constitutes the feed of the heat pump 42.

The compressor 46 is arranged downstream of the evaporator 44, wherein the condenser 48 is arranged downstream of the compressor 46.

The condenser 48 forms the outlet for the useful heat of the heat pump 42.

The throttle 50 is finally arranged downstream of the condenser 48 and upstream of the evaporator 44.

The first heat transfer circuit 38 comprises a first heat exchanger 52 as well as a pump 54. Thermal oil or pressurised water can be used as a heat transfer medium.

The feed of the heat pump 42, i.e. the compressor 46 here, is also arranged within the first heat transfer circuit 38.

In the shown embodiment, the feed is downstream of the pump 54 so that the pump 54 is located between the first heat exchanger 52 and the feed.

The first heat exchanger 52 is formed irrespective of the medium that carries the exhaust heat of the source unit 30. In the example discussed, this is air so that the first heat exchanger 52 is designed as an air heat exchanger.

The first heat exchanger 52 receives the exhaust heat, thus the exhaust air, of the source unit 30.

The first heat transfer circuit 38 thus provides a thermal connection between the source unit 30 and the feed of the heat pump 42 (thus here the evaporator 44).

The second heat transfer circuit 40 thermally connects the outlet of the heat pump 42 to the heat sink unit 32.

The heat transfer medium of the second heat transfer circuit 40 can be thermal oil or pressurised water.

The second heat transfer circuit 40 comprises a pump 56 in the first embodiment, wherein both the outlet of the heat pump 42 (in the shown embodiment thus the condenser 48) as well as the heat sink unit 32 are integrated into the second heat transfer circuit 40.

The heat transfer circuit 40 transitions, for example at the entrance 33 into the heat transfer circuit of the heat sink unit 31 and feeds the mixing units 36 and optionally even the rollers 34 with the heat transfer medium.

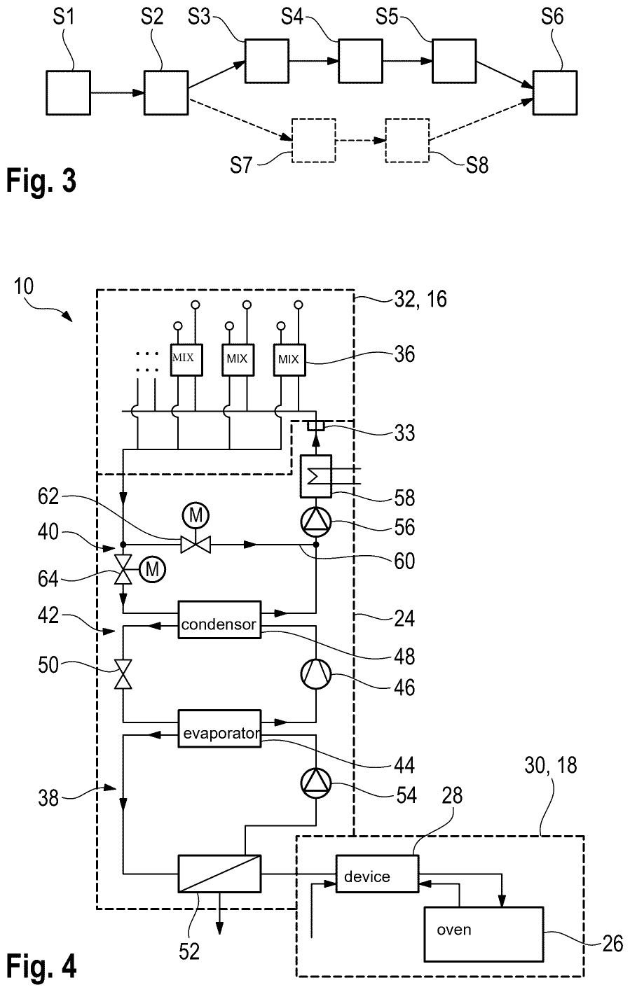

During the operation of the system 10, in particular in the production of plastic films, the method is executed that is shown schematically in FIG. 3.

During operation of the system 10, the source unit 30 generates exhaust heat. In the example, the oven 25 of the transverse direction orienter 18 generates exhaust heat in the form of exhaust air (S1).

The exhaust heat is fed to the oven 26 in part again as process heat by means of the device 28 for heat recovery.

The exhaust heat of the device 28, i.e. the now slightly cooled exhaust air from the oven 26, is the exhaust heat of the source unit 30 and, for example, has a temperature level ranging from 60° C. to 140° C.

In S3, the exhaust heat of the source unit 30 is fed to the heat pump unit 24, more specifically, the first heat exchanger 52 of the first heat transfer circuit 38.

The exhaust heat of the source unit 30 is now transferred into the heat transfer medium of the first heat transfer circuit 38 and supplied to the feed of the heat pump 42 (here the evaporator 44) (S4).

Subsequently, the exhaust heat of the source unit 30 is fed to the heat pump 42.

The temperature of the heat transfer medium in the first heat transfer circuit 38 directly downstream before the evaporator 44 is regarded as the feed temperature of the heat pump 42.

The feed temperature of the heat pump 42 ranges, for example, between 55° C. and 140° C.

At its outlet for useful heat (i.e. at the condenser 48 in the shown embodiment), the heat pump 42 now heats the heat transfer medium of the second heat transfer circuit 40 to a temperature level that exceeds the temperature level of the advanced feed of the heat pump 42 (S5)

For example, the temperature of the heat transfer medium in the second heat transfer circuit 40 is between 90° C. and 160° C. directly downstream of the heat pump 42, wherein temperatures of 200° C. and more are also conceivable.

The useful heat generated in this way is fed to the heat sink unit 32 as process heat by means of the second heat transfer circuit 40.

In the shown embodiment, the rollers 34 of the machine direction orienter 16 are heated by means of the supplied process heat.

In this way, the exhaust heat of the source unit 30 is reused extremely efficiently, thereby making it possible to considerably increase the energy efficiency of the entire system 10.

The FIGS. 4 to 8 show further embodiments of a system according to the disclosure and correspond substantially to the embodiment discussed previously. Therefore, only the differences are discussed hereinafter and the same parts and parts with the same function are provided with the same reference signs.

FIG. 4 shows a part of a system 10 in a second embodiment in a view similar to FIG. 2.

In contrast to the first embodiment, the system 10 now comprises an additional heater 58.

The additional heater 58 is located in the second heat transfer circuit 40 and is configured to heat the heat transfer medium of the second heat transfer circuit 40. For example, it is an electrically powered heater, such as a heating coil. The use of a heat exchanger as additional heater 58 is also conceivable.

The additional heater 58 is arranged downstream of the heat pump 42 and upstream of the heat sink unit 32.

Moreover, the second heat transfer circuit 40 comprises a bypass section 60 in this embodiment, in said bypass section 60 a bypass valve is provided which can close the bypass section 60.

The bypass section branches downstream of the heat sink unit 32 and upstream of the heat pump 42 from the remaining section of the circuit, bypasses the heat pump 42 and opens again into the remaining section of the circuit downstream of the heat pump 42 and upstream of the additional heater 58.

In addition, a shut-off valve 64 can be provided in the second heat transfer circuit 40 that is arranged upstream of the heat pump 42 and downstream of the branch of the bypass section 60.

By means of the additional heater 58, the heat transfer medium can be heated in the second heat transfer circuit 40 additionally or alternatively to the heat pump 42.

As a result, other useful heat can be provided to the heat sink unit 32 as process heat alternatively or in addition to the heat pump 42 (S7, in FIG. 3 indicated by dashed lines).

If the heat sink unit 32 has a particularly high demand for process heat, for example in starting up the unit, the additional heater 58 can be switched on. The additional heater 58 then also supplies other useful heat, in addition to the useful heat provided by the heat pump 42, in order to attain the required temperature level at the entrance 33 or at the process heat supply of the heat sink unit 32.

If the temperature in the second heat transfer circuit 40 directly downstream of the heat pump 42 is lower than the return temperature of the second heat transfer circuit 40, i.e. the temperature downstream of the heat sink unit 32, operation of the heat pump 42 is not possible.

In this case, the bypass valve 62 is open and (if this is not yet closed) the shut-off valve 64 is closed, thereby bypassing the heat pump 42 (S8, in FIG. 3 indicated by dashed lines).

The entire process heat for the heat sink unit 32 is then generated by the additional heater 58. This can also be necessary at the start of the operation of the system 10 if the source unit 30 does not provide enough exhaust heat.

Moreover, a heat pump 42 with lower heat output can be used as a result of the additional heater 58 as peak power outputs can be met by the additional heater 58. Consequently, the costs of the system 10 are lowered.

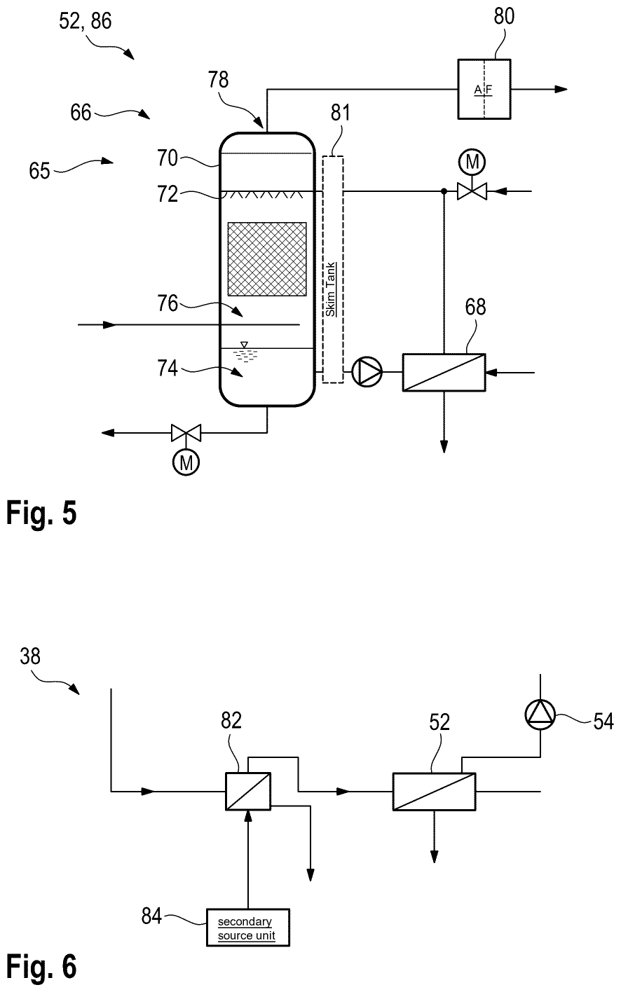

FIG. 5 shows an embodiment of the heat exchanger 52 of the first heat transfer circuit 38. This embodiment can be used in each of the remaining embodiments as said or one of the heat exchangers of the first heat transfer circuit 38

In this embodiment, the heat exchanger 52 comprises a gas scrubber 66 as well as a liquid heat exchanger 68. The gas scrubber 66 and an optional air filter 80 can be part of an exhaust air purification system 65.

The gas scrubber 66 comprises a flow vessel 70 that the exhaust air flows through; in said flow vessel 70, a liquid atomizer 72 as well as a liquid reservoir 74 are provided. In addition, the flow vessel 70 has an exhaust air inlet 76 as well as an exhaust air outlet 78.

The liquid atomizer 72 is located in the flow vessel 70 between the exhaust air inlet 76 and the exhaust air outlet 78.

The liquid reservoir 74 is located on the side of the exhaust air inlet 76 that faces away from the liquid atomizer 72.

This is the simultaneously the underside of the flow vessel 70.

The liquid reservoir 74 is connected to the intake of the liquid heat exchanger 68 and the liquid atomizer 72 is connected to the outflow of the liquid heat exchanger 68.

A pump is located between the liquid reservoir 74 and the liquid heat exchanger 68.

During operation, the exhaust air of the source unit 30 flows through the exhaust air inlet 76 into the flow vessel 70 and flows out of the flow vessel 70 at the exhaust air outlet 78.

Simultaneously, liquid atomized at the liquid atomizer 72 is fed into the flow vessel 70 so that the exhaust air of the source unit 30 flows through the atomized liquid. Here, impurities in the exhaust air dissolve, in particular hydrocarbons, thereby purifying the air. Simultaneously, the heat of the exhaust air is transferred to the liquid.

The liquid in the liquid reservoir 74 is thus heated and contains a part of the exhaust heat of the exhaust air of the source unit 30.

This liquid is then pumped to the liquid heat exchanger 68, in which the heat contained therein in transferred into the first heat transfer circuit 38.

In addition, the gas scrubber 66 can comprise an air filter 80, such as an electrostatic precipitator, which is arranged downstream of the flow vessel 70 in the exhaust air flow.

In a variation, a skim tank 81 can be provided (indicated in FIG. 5 by dashed lines) which is located between the flow vessel 70 and the liquid heat exchanger 68.

The liquid reservoir 74 and the liquid atomizer 72 are connected to the skim tank 81, thereby forming a circuit.

Simultaneously, the skim tank 81 is connected to the liquid heat exchanger 68.

During operation, heated liquid from the liquid reservoir 74 in directed into the skim tank 81 so that the liquid in the skim tank 81 is heated.

The heated liquid in the skim tank 81 is then fed to the liquid heat exchanger 68 which can remove the heat of the liquid in part. Cooled liquid is then fed again to the skim tank 81.

It is possible to forgo the liquid reservoir 74 in this alternative. Instead, a liquid outlet can be provided on the flow vessel 70.

In FIG. 6, a further embodiment is shown that can be combined with any other said embodiments.

In this embodiment, the first heat transfer circuit 38 has a second heat exchanger 82.

The second heat exchanger 82 is in contact thermally with a secondary source unit 84, i.e. the exhaust heat of the secondary source unit 84 directly adjoins a second heat exchanger 82, for example as exhaust air or as cooling water. The second heat exchanger 82 is, for example, an air heat exchanger or a liquid heat exchanger.

The same units that have already been listed for the source unit 30 can also be taken into consideration as a secondary source unit 84.

For example, the second heat exchanger 82 is provided upstream of the first heat exchanger 52.

In this way, exhaust heat of several units 30, 74 can be taken by the heat pump 42 and thus can be provided as process heat to the heat sink unit 32.

The secondary source unit 84 provides in particular a lower amount of exhaust heat as the source unit 30, and thus the arrangement of the second heat exchanger 82 upstream of the first heat exchanger 52 is particularly efficient as then there is a greater temperature difference and thus a higher degree of heat transfer.

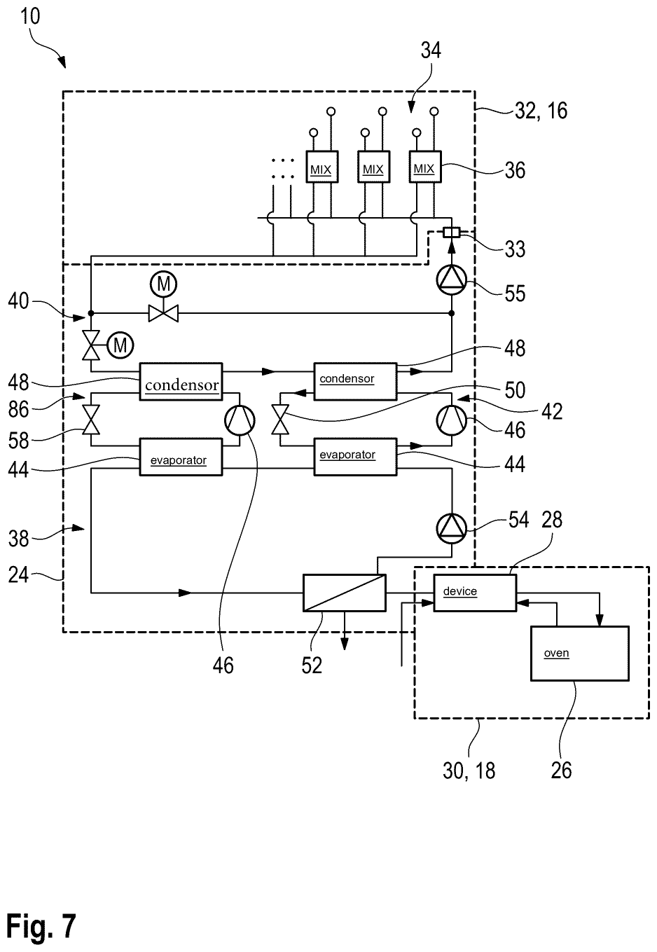

In FIG. 7, a fourth embodiment of the part of the system 10 is shown that is similar to the FIGS. 2 and 4.

In this embodiment, the heat pump unit 24 comprises several heat pumps, in the example a first heat pump 42 and a second heat pump 86.

The first heat pump 42 is designed like the heat pump 42 of the previous embodiments and is located in the heat pump unit 24.

The second heat pump 86 is designed in the same way as the first heat pump 42 and is arranged parallel to the first heat pump 42 between the first heat transfer circuit 38 and the second heat transfer circuit 40.

The feed of the heat pump 42, also here the evaporator 44, is arranged in the first heat transfer circuit 38 and the outlet of the heat pump 42, thus here the condenser 48, is arranged in the second heat transfer circuit 40.

In the shown embodiment, the feed of the second heat pump 86 is arranged downstream of the feed of the first heat pump 42 in the first heat transfer circuit 38, whereas the outlet of the second heat pump 86 is arranged upstream of the outlet of the first heat pump 42 in the second heat transfer circuit 40.

In particular, the feeds of the heat pumps 42, 86 and also the outlets of the heat pumps 42, 86 are arranged in series.

The arrangement of the outlets in the second heat transfer circuit 40 is with regard to the flow of the heat transfer medium thus in the reverse order as the arrangement of the feeds in the first heat transfer circuit 38.

For example, the temperature of the first heat transfer medium of the first heat transfer circuit 38 is 85° C. at the feed of the first heat pump 42 and the residual temperature is still 55° C. at the feed of the second heat pump 86. Both heat pumps 42, 86 heat the heat transfer medium of the second heat transfer circuit 40 to a temperature of 148° C.

In contrast to an individual heat pump with increased power, by using the second heat pump 86, two heat pumps with reduced power, but a greater degree of efficiency can be used. The higher degree of efficiency is achieved as the heat pumps 42, 86 each only have to be designed for a smaller temperature performance range. Despite the high investment costs, the operation costs can be lower as when using a single heat pump.

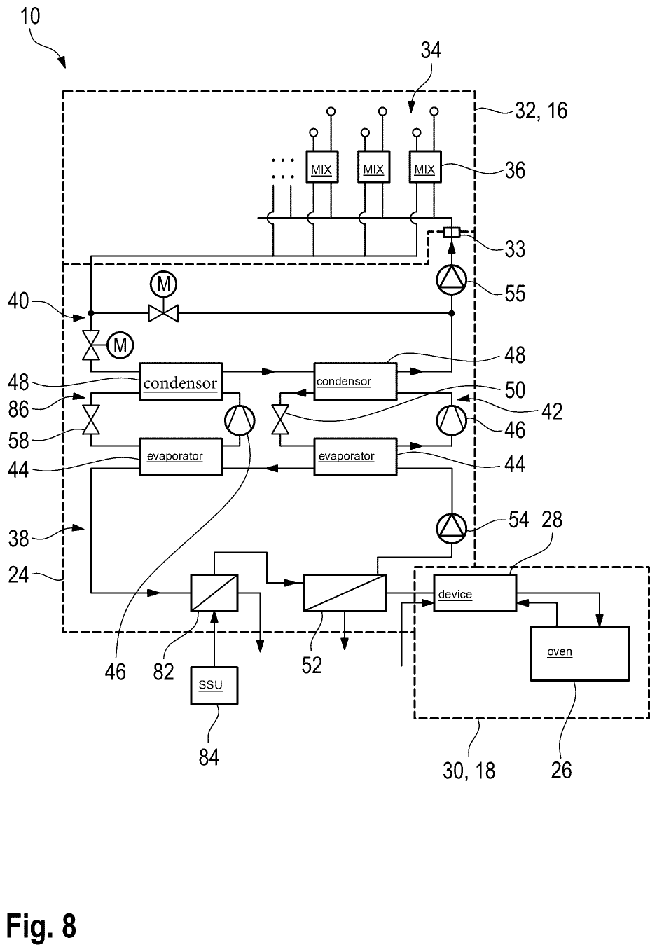

The fourth embodiment shown in FIG. 8 corresponds to the third embodiment shown in FIG. 7, wherein the embodiment shown in FIG. 6 is applied in which a secondary source unit 84 brings additional heat into the first heat transfer circuit 38 via a second heat exchanger 82.

Also in this embodiment, one or both of the heat exchangers 52, 82 can be designed like the heat exchanger according to the embodiment of FIG. 5.

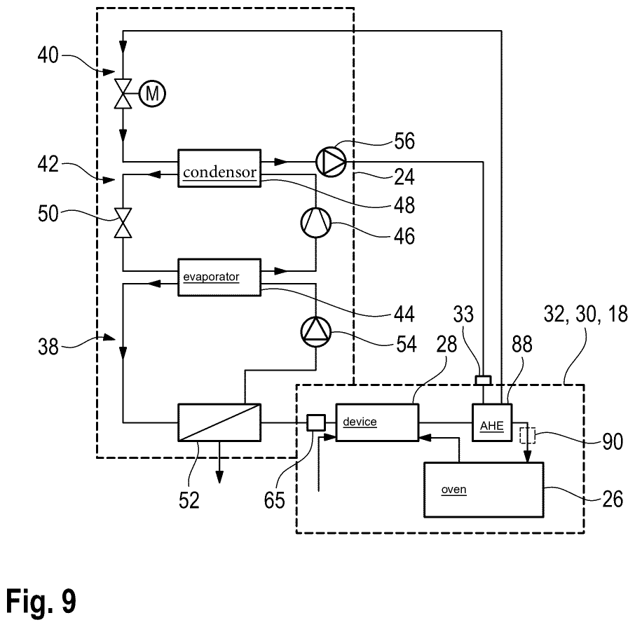

In FIG. 9, a fifth embodiment of the system 10 according to FIG. 1 is shown extremely schematically. This embodiment is based on the first embodiment, wherein the remaining embodiments could also serve as a starting point.

In particular, the system 10 of this fifth embodiment has an exhaust air purification system 65 as described for the embodiment according to FIG. 5 and a heat exchanger 52 of the first heat transfer circuit 38 comprising a gas scrubber 66 as described for the embodiment according the FIG. 5.

In this embodiment, the heat sink unit 32 is the transverse direction orienter 18 of the system 10. The transverse direction orienter 18 can also be the source unit 30 so that the transverse direction orienter 18 and the heat sink unit 32 are the same unit.

Correspondingly, the transverse direction orienter 18 comprises an entrance 33 and also an air heat exchanger 88.

The air heat exchanger 88 is located in the second heat transfer circuit 40 and receives the heated heat transfer medium from the heat pump 42.

The air heat exchanger 88 is arranged downstream of the device 28 for heat recovery of the transverse direction orienter 18, but upstream of the oven 26.

The air heat exchanger 88 thus also receives a flow of fresh air preheated by the device 28 for the oven 26 which is heated further by the air heat exchanger 88.

The fresh air heated in this way is then fed to the oven 26, for example to the preheating zone.

For redundancy in the case of failures of the heat pump 42 or for adjustment of the temperature level, a damper register 90 can be arranged between the device 28 for heat recovery and the oven 26 in the flow path of the fresh air, in particular downstream of the air heat exchanger 88.

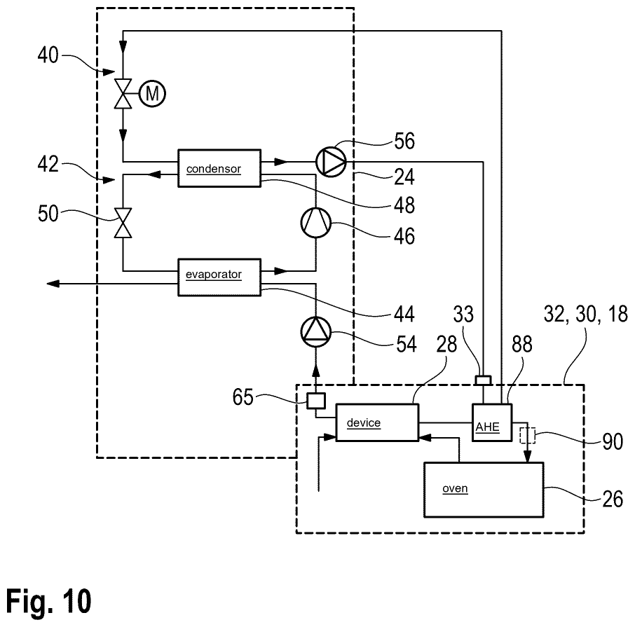

In FIG. 10, a sixth embodiment is shown that is based on the fifth embodiment.

In this sixth embodiment, a first heat transfer circuit 38 is not provided, but the exhaust air of the source unit 30, in particular the exhaust air of the device 28 for heat recovery, is directed to the evaporator 44 of the heat pump 42.

To this end, the evaporator 44 is arranged upstream of the exhaust air purification system 65 as described for FIG. 5. After passing through the gas scrubber 66 and the optional air filter 80, the exhaust air purified by the air purification system 65 goes directly to the evaporator 44.

Thus, the first heat transfer circuit 38 can be saved.

It is conceivable that also in the other embodiments the exhaust air or the exhaust heat present in the liquid of the source unit 30 is directed directly to the evaporator 44 of the heat pump 42.

The exhaust air flow cooled after the evaporator 44 of the heat pump 42 or the heat exchanger 52 of the first heat transfer circuit 38 can be used in every embodiment for cooling in the cooling zone of the transverse direction orienter 18, as low temperature heat in other processes or for heating a building.

Irrespective of the embodiment, condensation can arise at the evaporator 44 or at the heat exchanger 52 of the first heat transfer circuit 38 that forms through the cooling and/or expansion of the exhaust air of the source unit 30. This water can be fed to a gas scrubber, such as a gas scrubber 66 of the embodiment according to FIG. 5 in order to thus reduce the necessary replenishment quantity of processed fresh water.

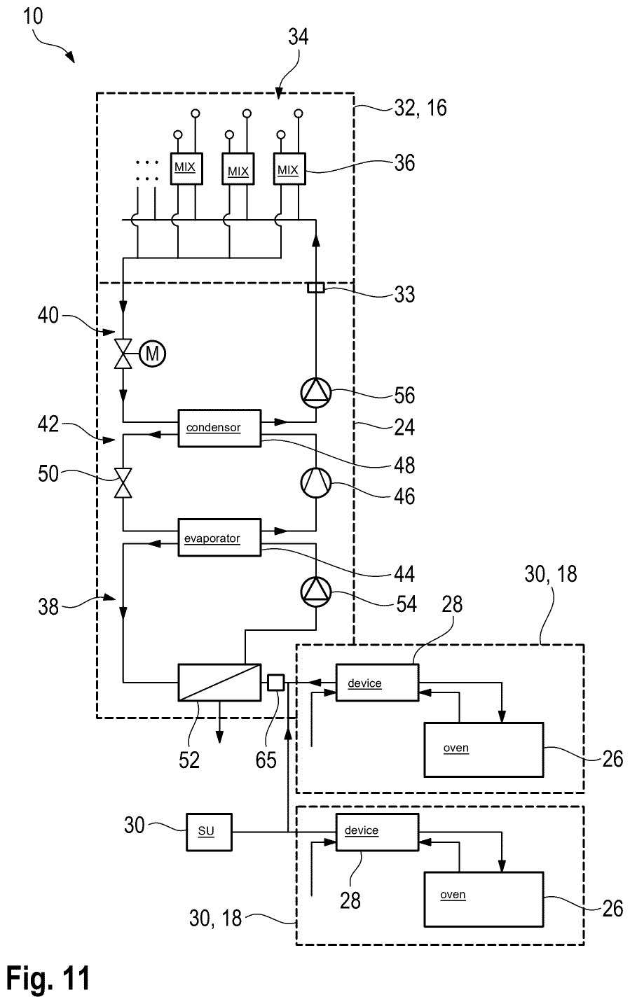

In FIG. 11, a system 10 is shown that comprises several source units 30, for example two transverse direction orienters 18 and a further unit. It is also conceivable that the system 10 comprises two or more than three source units 30.

The exhaust air flow of the source units 30 are combined and fed together to the evaporator 44 of the heat pump 42 or the heat exchanger 52 of the first heat transfer circuit 38.

One or more air purification systems 65 can also be used here as described for FIG. 5. For example, the air purification system 65 purifies the exhaust air flows already combined together so that only one air purification system 65 is required.

1. System for producing plastic films comprising
a source unit,
a heat sink unit and
a heat pump,
wherein the heat pump comprises a feed for heat and an outlet for useful heat,
wherein the source unit comprises an exhaust heat outlet that is connected thermally to the feed of the heat pump, and
wherein heat sink unit comprises a process heat supply that is connected thermally to the outlet of the heat pump.

2. System according to claim 1, wherein at least one of the feed of the heat pump is an evaporator or the outlet of the heat pump is a condenser.

3. System according to claim 1, wherein the system comprises a first heat transfer circuit that thermally connects the source unit to the heat pump.

4. System according to claim 3, wherein the first heat transfer circuit comprises a first heat exchanger that is connected thermally to the exhaust heat outlet of the source unit.

5. System according to claim 4, wherein the first heat exchanger is an air heat exchanger or a liquid heat exchanger.

6. System according to claim 4, wherein the system comprises a secondary source unit and the first heat transfer circuit comprises a second heat exchanger, wherein an exhaust heat outlet of the secondary source unit is thermally connected to the second heat exchanger.

7. System according to claim 4, wherein the exhaust heat outlet of the source unit is an exhaust air outlet, wherein the first heat exchanger comprises a gas scrubber and a liquid heat exchanger.

8. System according to claim 1, wherein the system comprises a second heat transfer circuit that thermally connects the heat sink unit to the heat pump.

9. System according to claim 8, wherein the system comprises an additional heater that is located in the second heat transfer circuit downstream of the heat pump and upstream of the heat sink unit.

10. System according to claim 9, wherein the second heat transfer circuit comprises a bypass section with a bypass valve, wherein the bypass section at least one of opens downstream of the heat pump and upstream of the additional heater or originates from a point upstream of the heat pump and downstream of the heat sink unit.

11. System according to claim 1, wherein the system comprises two heat pumps that are connected in parallel between the source unit and the heat sink unit.

12. System according to claim 11, further comprising:
a first heat transfer circuit that thermally connects the source unit to the heat pumps, and
a second heat transfer circuit that thermally connects the heat sink unit to the heat pumps, wherein at least one of feeds of the heat pumps are arranged in series in the first heat transfer circuit or outlets of the heat pumps are arranged in series in the second heat transfer circuit.

13. System according to claim 6, wherein at least one of the source unit or the secondary source unit is at least one of a stretching unit, an extrusion unit, a casting unit or a draw roller unit; and/or the heat sink unit is at least one of a stretching unit, a crystalliser, a raw material drying unit or a water bath of a simultaneous stretching unit.

14. System according to claim 13, wherein the stretching unit is at least one of a transverse direction orienter, a main direction orienter or a simultaneous stretching unit.

15. System according to claim 1, wherein the source unit comprises a device for heat recovery, wherein the exhaust heat outlet of the device for heat recovery is the exhaust heat outlet of the source unit.

16. Method for operating a system for producing plastic films comprising a source unit, a heat sink unit and a heat pump, wherein the method comprises:
feeding exhaust heat of the source unit to the heat pump, and
feeding useful heat from the heat pump to the heat sink unit as process heat.

17. Method according to claim 16, wherein exhaust heat of the source unit is the exhaust heat of a device for heat recovery of the source unit.

18. Method according to claim 16, wherein other useful heat is supplied to the heat sink unit to the useful heat of the heat pump which generates additional heating of the system.

19. Method according to claim 18, wherein the other useful heat is generated in a second heat transfer circuit of the system that directs the useful heat of the heat pump to the heat sink unit.

20. Method according to claim 19, wherein a bypass valve is opened in a bypass section of the second heat transfer circuit, which bypasses the heat pump, and a shut-off valve is closed upstream of the heat pump if a return temperature from the heat sink unit in the second heat transfer circuit exceeds the temperature in the second heat transfer circuit directly downstream of the heat pump.
